(19) United States
(12) Patent Application Publication
(10) Pub. No.: US 2004/0205196 A1
(43) Pub. Date: Oct. 14, 2004

(54) Signaling protocol

(75) Inventors: Uwe Schneider, Weingarten (DE); Stefan Rinke, Ettlingen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: WEB.DE AG, Karlsruhe (DE)

(21) Appl. No.: 10/395,951

(22) Filed: Mar. 24, 2003

(51) Int. Cl. G06F 15/16

(52) U.S. Cl. 709/228; 709/230

(57) ABSTRACT

A signaling protocol for a client and a server in a communications environment includes providing information about another communication environment to at least one of the client and the server.

### BACKGROUND

In general, the present invention relates to signaling in a communications environment. In particular, the present invention relates to a signaling protocol, or method for signaling, in a communications environment, wherein signaling provides information with respect to another communications environment. Further, the present invention relates to a communications environment, a method, a client, a server and software program products for implementing or carrying out the signaling protocol to which present invention relates to.

A communications environment may be a communications system comprising more than one component, i.e., more than one device and/or type of device, media and/or type of media, network and/or type of network. Thus, a communications environment or communications system might for instance comprise a telephone, a Public Switched Telephone Network (PSTN), a gateway to the Internet, etc.

Today, several different communications environments are known, for example computer based communications environments such as the Internet, communications environment comprising telephone networks, such as PSTN-based telephone communication environments, Global System for Mobile Communication (GSM) communications environments, Universal Mobile Telecommunications System (UMTS) communications environments and the like. Although existing communications environments exhibit a plurality of communications capabilities, the communications environments are generally isolated from each other. Thus, communications performed in one communication environment are separated from communications performed in another communications environment. A result, in a communications environment used for communications no information is provided with respect to a second communications environment regarding communications performed in the second communications environment.

### SUMMARY OF THE INVENTION

A general object of the present invention is to overcome the presently existing isolated coexistence of communications environments. In particular, an object of the present invention is to provide access in one communications environment to information about a second communications environment, specifically information about communications performed in the second communications environment.

The present invention provides a method for signaling, or a signaling protocol, between a client and a server in a first communications environment. The method includes providing information about a second communication environment to at least one of the client and the server.

The information may be provided in real-time by actively communicating the information from the client to the server and/or from the server to the client. Moreover, the server may be a telecommunications website and the client a specific entity associated with the telecommunications website. Properties and functions of a telecommunications web site are described in commonly-assigned U.S. patent application Ser. No. 10/201,446, entitled “Communications Environment,” filed Jul. 23, 2002, and in commonly-assigned U.S. patent application entitled “Web Site Having an Event Identification Element” (attorney docket number 5007.1008), both of which are hereby incorporated by reference herein.

The information may be provided using a protocol data unit configured for the information. The protocol data unit may include any of a first protocol data unit portion configured to indicate a version of a signaling protocol, a second protocol data unit portion configured to indicate a number of the protocol data unit, a third protocol data unit portion including a time stamp, a fourth protocol data unit portion including data useable by at least one of the client and the server, and a fifth protocol data unit portion including a signature.

The present invention also provides a communications environment comprising a client and a server, the client and/or the server being capable of providing information about a second communication environment to the other.

The present invention also provides a computer readable medium having stored thereon computer executable process steps operative to perform a method for signaling between a client and a server in a first communications environment. The method includes providing information about a second communication environment to at least one of the client and the server.

In this context, information with respect to the second communications environment comprise data and/or information indicating operation modes of the second communications environment currently existing and/or desired/requested by the client and/or the server and communications performed in the second communications environment.

Preferably, the signaling protocol defines a signaling that is to be actively communicated from the client to the server and/or vice versa. Thus, the signaling according to the signaling protocol of the present invention is based on pushes from the client and/or the server (bi-directional pushing) such that polling of the client and/or the server is not necessary. This allows for a real-time signaling.

Preferably, the signaling protocol according to the present invention is used for a signaling to be communicated between a specific entity as the client and a telecommunications website as the server associated to the client. A telecommunications web site may be a web site adapted to provide, upon an access event, for private communications between two entities. A telecommunications web site is assigned to or personalized for or corresponding to a specific person or entity. Such a specific entity can be a person, a company or any other entity. Telecommunications web sites and specific entities are further discussed below.

In this context, the first communications environment comprises the specific entity and the telecommunication website which corresponds to the specific entity. In this case, the first communications environment can comprise a computer-based communications environment system or network, such as the Internet.

In order to provide for a secure signaling including identification and authentication, in particular with the respect to the client, it is contemplated that the signaling protocol according to the present invention defines that any signaling communicated according thereto will be signed by a signature on the client CL and/or will be encrypted on the clients side. Preferably, the encryption is performed subsequent to signing a message.

Further, it is contemplated that the signaling protocol according to the present invention defines that, on the server SV, received signaling is decrypted and/or the signature is retrieved from signaling received by the server. In order to check the validity of the signature, the server can compare the retrieved signature with a signature calculated on the server SV or obtained by other means.

Preferably, the signaling protocol according to the present invention defines that each signaling comprises different protocol data units for providing the information with respect to the second communications environment.

The signaling protocol can further define that each of the protocol data units compromises a first protocol data unit portion indicating a version of the signaling protocol, second protocol data unit portion indicating the number of the respecting protocol data unit, a third protocol data unit portion including a time stamp, a fourth protocol data unit portion including data useable by at least one of the client and the server and a fifth protocol data unit portion including a signature.

Here, the fifth protocol data unit portion can include a signature of the first, second, third and fourth protocol data unit portions as the signature.

The first, second, third, fourth and fifth protocol data unit portions can be symmetrically encrypted, in particular according to the RC 4 stream cipher.

Further, the signature in the fifth protocol data unit portion can be retrieved/obtained on the server SV by means described in the RFC 2104 standard for cryptography, the so-called “request for command.” Also it is possible that the first, the second, the third and the fifth protocol data unit portion each has a predefined length.

The first protocol data unit portion can represent a number of the version of the signaling protocol currently used, for example for example protocol version one.

The second protocol data unit portion can indicate the number of its protocol data unit. In view of the numbering of protocol data unit exemplary used herein, reference may now be made to an embodiment of the signaling protocol according to the present invention according to which a so-called initialization protocol data unit is defined.

The initialization protocol data unit represents also a protocol data unit for a signaling but can have a different structure with respect to its portions. In particular, the initialization protocol data unit can comprise a first portion indicating the current version of the signaling protocol, a second unit indicating the number of this protocol data unit, a third portion indicating a time stamp generated on the client CL, a fourth portion indicating a major client version indicating major changes of the version (e.g., new functionalities), a fifth portion indicating a minor client version indicating minor changes of the version (e.g., error/bug corrections, design modifications), a sixth portion indicating a session cipher, for example according to RC 4, a seventh portion indicating a length of a session key in bytes, for example 16 bytes, an eighth portion indicating the session key generated on the client CL and a ninth portion indicating a signature generated on the client CL comprising 64 byte. Preferably the packet is further encrypted by a public key method, such as, for example, an asymmetric encryption method or a method using the RSA algorithm.

The initialization protocol data unit is used by the client to contact the server to request that a signaling with respect to the second communications environment is desired. Therefore, the initialization protocol data unit is a signaling in initializing or initiating a signal according to the signaling protocol of the present invention. Therefore, this protocol data unit has the number 1. In the following, different protocol data units and respective numbers are listed. The numbers associated to the protocol data units are just of exemplary character which also applies for the numbers contemplated for the in initializing protocol data unit.

As protocol data unit 2, the present invention contemplates a server-hello-signaling from the server to the client.

Further the present invention contemplates a protocol data unit 3 for a client-login-signaling from the client to the server, a protocol data unit 4 for login-response-signaling from the server to the client, a protocol data unit 5 for a keep-alive-request-signaling from the client to the server, a protocol data unit 6 for a keep-alive-response-signaling from the server to the client, a protocol data unit 7 for a logout-signaling from the client to the server, a protocol data unit 8 for a line-state-message-signaling from the server to the client, a protocol data unit 9 for a new-server-state-signaling from the server to the client, a protocol data unit 10 for a line-action-signaling from the client to the server, a protocol data unit 11 for a resynchronization-request-signaling from the client to the server, a protocol data unit 12 for a login-to-session-signaling from the client to the server and a protocol data unit 13 for an error-message-signaling from the server to the client. With respect to these protocol data units, it is referred to the description of preferred embodiments of the present invention for a more detailed description thereof.

Further, the present invention provides a communications environment comprising a client and a server for communicating with each other by means of a first communications environment. In particular, the communications environment according to the present invention utilizes a signaling according to an embodiment of the signaling protocol according to the present invention for providing information with respect to a second communications environment at least to one of the client and the server.

Preferably, the client of the communications environment according to the present invention is a specific entity which a telecommunications web site is associated to while the server thereof is at least partially represented by the telecommunications web site associated to the specific entity.

### BRIEF DESCRIPTION OF THE DRAWINGS

In the following description, the present invention is elaborated upon based on exemplary embodiments, with reference to the drawings.

FIG. 1 shows a schematic diagram depicting a client and a server in a first communications environment and end user units of a network a second communications environment.

FIG. 2 shows a schematic diagram depicting a specific entity and a telecommunications web site in a first communications environment and telephones of a telephone network in a second communications environment.

### DETAILED DESCRIPTION

The signaling protocol according to the present invention is also referred to herein as a telecommunications web site signaling protocol. Data exchange for this signaling protocol is telegram-oriented and “light weighted”. This is to enable a server utilizing that signaling protocol to handle a plurality of clients. Further, all data exchanges or “telegrams” are idempotent in their semantics. Thus a double transmission can be achieved without problems. Further, data communications are secure since they are private and authenticated both from the server-side and the client-side. As set forth above, data polling is not employed in general. Rather, a client communicates its signaling to the server via a push of data while the server also communicates its signaling as push. Moreover, signaling characterized measures, modifications, actions and variations to be carried out with respect to a communications environment are generally not immediately answered by a respective return signaling. Rather, such a return signaling will be communicated upon the intended/desired modification etc. with respect to the particular communications environment is actually effected. For data communications according to the protocol described here, a user datagram protocol UDP is employed.

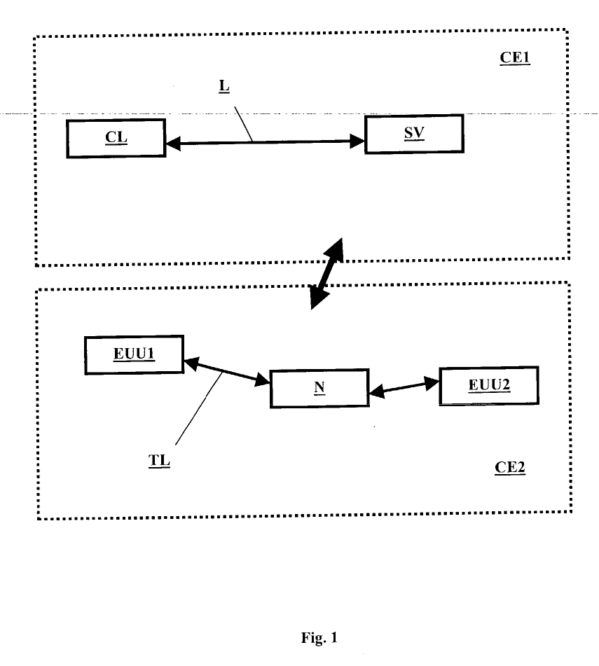

As illustrated in FIG. 1, a first communications environment CE1 comprises a plurality of clients of which only client CL is shown is shown in that figure and a server SV which can be embodied as hardware and/or software server. A communication between the client CL and the server SV is executed via a communications link L. Examples for this communications link comprise any wired and/or wireless transmission lines capable of transmitting data and/or information.

Further, FIG. 1 illustrates a second communications environment CE2 wherein by means of a network communications between at least two end user units can be performed. For illustrative purposes, only two end user units EUU1 and EUU2 are shown. It is contemplated that communications originating from one of the end user units in the second communications environment CE2 can be routed from the second communications environment CE2 to another communications environment such as the first communications environment CE1 or any other communications environment. With respect to the first communications environment CE1 this is illustrated by means of the arrow from the network N to the first communications environment CE1 and vice versa.

The network N can be, for example, a telephone network, while the end user units EUU1 and EUU2 can be units or devices comparable to a telephone or providing its functions. In other embodiments, the end user units EUU1 and EUU2 may be another device that can be used for communications, for example a keyboard, a computer terminal, a mobile phone, a fax, a telex, a mail pigeon, an ordinary letter, a scanner, a PSTN device, a Third Generation (3G) wireless communications device, especially a UMTS device, etc. Moreover, the end user unit may be a telecommunications web site, a telecommunications portal comprising more than one telecommunications web sites or a device using a browser-based application.

The signaling protocol according to the present invention is, as set forth above, employed to exchange information between the client CL and the server SV with respect to the second communications environment CE2. In particular, the signaling protocol according to the present invention provides for a signaling characterizing desired, requested, prevailing and actually existing operation modes of the second communications environment CE2 with respect to an end user unit and its communications via the network N. Specifically, the end user to which a signaling according to the present invention between the client CL and the server SV relates to is an end user unit being associated to the client. As illustrative example, the client CL can be a personal computer while the end user unit to which a signaling according to the present invention to and from the client CL is related to can be a telephone or any other communications unit which can be or is used by the user of the personal computer representing the client CL.

In order to promote an understanding of the present invention, in the following it is assumed that the client CL is a computer-based end user unit such as a personal computer, that the server SV is a system or unit comparable to a server known from the Internet, that the first communications environment CE1 comprises, at least partially, the Internet such that the communications link L is an Internet communication link, that the network N is a telephone network and the end user units EUU1 and EUU2 are telephones all thereof being comprised by the second communications environment CE2, thus, representing a telephone communications environment.

In view of this scenario, signaling according to the signaling protocol according to the present invention is communicated between the client CL and the server SV and provides information to the client CL and to the server SV with respect to intended/desired and carried out communications by means of the first end user unit EUU1. It is assumed that the first end user unit EUU1 is associated with the client CL, as set forth above.

The signaling protocol according to the present invention provides different functionalities that are, in line with the above assumptions, explained with respect to the telephone communications environment CE2.

For indicating from the client CL to the server SV that a signaling according to the signaling protocol of the present invention is requested, the functionality “login” for the client and, in response thereto, the functionality “acknowledgement” from the server SV are used.

With respect to conditions within the second communications environment CE2 relating to states of a telephone line connecting the network N and the end user unit EUU1, the signaling protocol according to the present invention provides the functionality “line state”. That functionality generally signalizes the state of the telephone line TL shown in FIG. 1. In particular, that functionality comprises a signaling “ring” indicating that a telephone line to the first end user unit EUU1 is desired from a third party, i.e. the telephone EUU1 of the user of the client CL rings. Further, the functionality “line state” provides for a signaling “hang up” indicating that the telephone line to the end user unit EUU1 terminated, i.e. that the user of the telephone EUU1 has put down the handset. Signaling and functionality in this regard are employed from the server SV to the client CL. This is due to the fact that the server SV obtains data and/or information in this regard from the second communications environment CE2. Examples of how such data and/or information can be provided to the server are explained below.

In order to enable the client CL to indicate to the server SV desired/requested actions with respect to a telephone line to and/or from the end user unit EUU1, the signaling protocol according to the present invention provides the functionality “line actions”. For example, that functionality provides for a signaling indicating that the user of the client CL wants to establish a telephone communications link or telephone line from his/her end user unit EUU1 to the end user unit EUU2, for example a telephone associated to another person. Acknowledgements from the server SV in this regard are assumed to be signaled implicitly, i.e., the received packet is not directly acknowledged or confirmed, but rather a change of sate of the server is signaled. For providing information from the server SV to the client CL, the functionality “server state” is provided. That functionality allows for informing the client CL about states, conditions, operational modes and the like within the second communications environment CE2 with respect to the end user unit EUU1 associated to the client CL. Further, the signaling protocol according to the present invention provides for the functionalities “keep alive”, “log out”, “time synchronization” and “packet delay” which will be explained in the description of protocol data units of the signaling protocol according to the present invention below. In order to inform both the client CL and the server SV in a unique manner with respect to a telephone line to and/or from the end user unit EUU1, all signaling related to that telephone line is characterized by a unique identification for that telephone line.

In general, signaling according to the signaling protocol of the present invention is encrypted, advantageously according to TLS 1.0/SSL 3.0. That means an asymmetrical handshake and a symmetrical session encryption is used without client certificates. The security of the signaling protocol according to the present invention is designed according to SSL standard. As a result, the server SV transmits a certificate including a public key. Subsequently, a session key provided from the client CL is encrypted with that key and used further on. As an option, it is contemplated that the signaling protocol according to the present invention does not support different certificates. Then, the step of transmitting a certificate including a public key from the server SV to the client CL can be omitted. Rather, in that case it is assumed that the public key is available on the client CL.

Further, the signaling protocol according to an embodiment of the present invention includes the following definitions:

Word: 16 bit

Long: 32 bit

Little/big endian: the line format is big endian, i.e., Most Significant Byte (MSB) first. Thus, the numeral 5 can be expressed as word as follows: 00 05. Byte steam (system of octets): MSB first. Bytes are integrated into a data bracket one after another.

Strings: Coding with lengths descriptors, i.e., one word length is followed by string data. In case of an uneven length, a padding byte is subsequently used. Example: “Haus=00 05 ‘H’ ‘a’ ‘u’ ‘s’ 00”. Not existing strings (empty strings) are coded as 00 00. Padding for symmetrical block ciphers: Since symmetrical ciphers often employ blocks having a predefined length, the lengths of the data packets are coded separately. Remaining space at the end of a data packet is padded with 0×AA 0×55 until the next block is reached. The length is coded by utilizing a word a the beginning.

The signaling protocol according to an embodiment of the present invention employs two different ciphers: An asymmetrical initialization cipher (according to RSA) and a symmetrical session cipher according to RC4.

From the protocol data unit defined in the signaling protocol according to an embodiment of the present invention, the initialization protocol data unit is only encrypted with the initialization cipher. Since the session cipher is proposed from the client CL, the session cipher is variable.

In order to provide security, all protocol data units of the signaling protocol according to an embodiment of the present invention are always encrypted. Further, all protocol data units are provided with a time stamp and are signed. Except for the initialization protocol data unit, all protocol data units of the signaling protocol according to an embodiment of the present invention are defined to include the following protocol data unit portions PDUP:

PDUP1: current version of the signaling protocol according to an embodiment of the present invention (e.g., 1); 1 word

PDUP2: protocol data unit number; 1 word;

PDUP3: time stamp; 2 words

PDUP4: usable data, x words

PDUP5: signature of PDUPs 1-4, 16 byte

The protocol data unit portions 1-5 are symmetrically encrypted. In case of RC4 this maintains the length of the protocol data units.

The time stamp in the protocol data unit portion 4 prevents replay attacks since, for a verification of the signature, the time stamp is additionally used for a plausibility assessment. In this context plausibility refers to a protocol data unit being “not too old”, for example not older than 30 minutes.

For checking a signature of a protocol data unit, the signature of a received protocol data unit is retrieved and compared with a calculated signature. A calculated signature obtained by means of the receiving party is calculated according to RFC 2104 as HMAC signature.

The initialization protocol data unit, also referred to as protocol data unit 1 (PDU1), provides for a so-called “client hallo” signaling from the client CL to the server SV and has the following format:

PDUP1: Protocol version (e.g., 1); 1 Word

PDUP2: PDU number 1; 1 Word

PDUP3: Time stamp; 1 Long

PDUP4: Client version major [indicating major changes of the version (e.g., new functionalities); example: In version 3.5 of the client, “3” represents the major version number and “5” the minor version number]

PDUP5: Client version minor [indicating minor changes of the version (e.g., error corrections); example: In version 3.5 of the client, “3” represents the major version number and “5” the minor version number]

PDUP6: Session cipher: 1 (RC4)

PDUP7: Session key length in Bytes (typically 16 Bytes)

PDUP8: Session key

PDUP9: Signature; 64 Bytes

The client generates the session key and the signature key.

Semantics for the client: “I contact the server and request capacities of the server. If capacities of the server are available, I inform the server of the server of my IP-address/port. If no server capacity is available, I expect a forwarding address. In case I do not receive any information from the server within a certain time period (e.g., 30 seconds), I try again.”

Semantics for the server: “A client having a peer-IP-address wants to register. In case, a session is already associated to this IP-address/port, I reject/dismiss this packet. If I have capacities available, I send a response (see “server hallo” signaling described below) and expect a response from the client within a predefined period of time (e.g., 1 minute). Otherwise, I reject/dismiss this client session. If I do not have any capacities available, I return a forwarding/redirecting address to the client. In case the received request is alleged to be a request from an intruder (e.g., DoS attack), I record this event and reject/dismiss the packet.”

The protocol data unit portions 3-9 transmitted to the server are encrypted with the initialization cipher algorithm. As a result, the format of the protocol data unit PDU1 can be given as:

PDUP1: Protocol version (e.g., 1); 1 Word

PDUP2: PDU number 1; 1 Word

PDUP3-9: Crypt data (RSA 1024); 128 Bytes

In response to the “client hallo” signaling, the server returns a so-called “server hallo” signaling. This return packet has the following structure:

PDUP1: Protocol version (e.g., 1); 1 Word

PDUP2: PDU number 2; 1 Word

PDUP3: Timestamp (Server time), 1 Long

PDUP4: Server version major

PDUP5: Server version minor

PDUP6: Acknowledge (Success: 1; Error: 0); 1 Word

PDUP7: Reason code (Success: 0); 1 Word

PDUP8: Redirect required (Yes: 1; No: 0); 1 Word

PDUP9: String: New Host: Format: HOST:PORT (optional in case of redirect)

PDUP10: HMAC over PDUP1-PDUP9; 16 Bytes

The protocol data unit portions 3-10 are encrypted with a session key and a session cipher. This applies also for the description of signaling structures and formats below.

Semantics for the server: “I inform the client that he is allowed to authenticate himself or that he should contact another server. In case I have capacities available for a client, I wait a certain period of time (e.g., 60 seconds) for an authentication of the client. Otherwise, I dismiss/reject the whole client context with respect to this IP-address/port.”

Semantics for the client: “If I receive a redirection/forwarding server address, I contact that address (e.g., a new URL) by means of a “client hallo” signaling. Otherwise, I authenticate myself to the server.”

For authentication, identification and login, the client employs a so-called “client login” signaling communicated from the client CL to the server SV which exhibits the following format:

PDUP1: Protocol version (e.g., 1); 1 Word

PDUP2: PDU number 3; 1 Word

PDUP3: Time stamp (Client time); 1 Long

PDUP4: Username; 1 String

i. Pass word; 1 String

PDUP5: Signature; 16 Bytes

Semantics for the client: “I transmit my login and the password of my account to the server. I expect an acknowledgement by the server within a certain period of time (e.g., 30 seconds). Otherwise I keep trying.”

Semantics for the server: “The client identified/known by its IP-address/port wants to log in. I check the validity of its account and inform the client in this regard.”

In response to the “client login” signaling, the server returns to the client a so-called “login response” signaling with the following structure:

PDUP1: Protocol version (e.g., 1); 1 Word

PDUP2: PDU number 4; 1 Word

PDUP3: Time stamp (Server time); 1 Long

PDUP4: Success/Error (e.g.,: Success=1, i.e. login and password correct; Error=0, i.e. login and/or password incorrect); 1 Word

i. Reason code (Success: 0; Error: 1)); 1 Word

ii. Session Identification SessionID (for later accesses per HTTPS, e.g., Session=fa34543978); 1 String

iii. Number of pairs of area tags and URLs; n×[number of pairs of area tags and URL in a packet]

iv. Area tag (e.g., “Hist”),1 String

v. URL prefix for area (e.g., “https://server.domain.com”); 1 String

vi. . . . [a list of string pairs indicating in an alternating manner area tags and URL prefixes for different client areas]

PDUP5: Signature; 16 Bytes

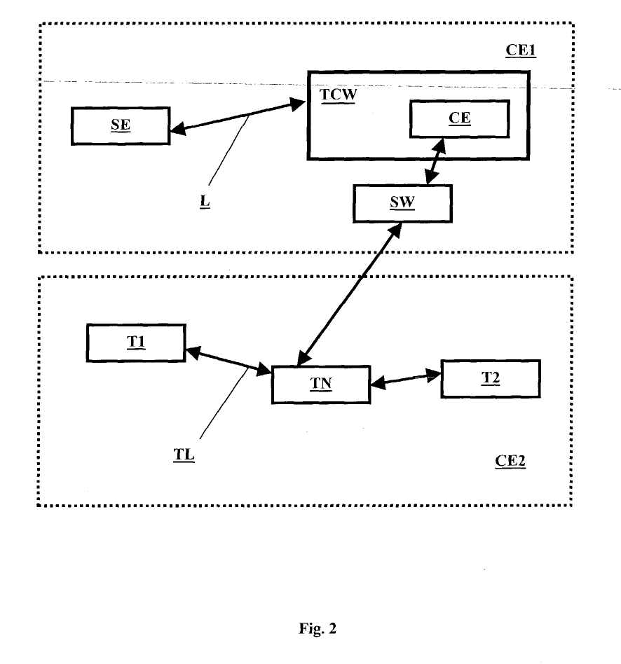

Semantics for the server: “I inform the client whether its login was accepted or not. In case the login was accepted, I inform the client about its session identification sessionID and provide at least one pair of HTML-area-tags and URLs by means of which the client is enabled to download content utilizing HTTPS. (In case of a telecommunications web site functioning as server: “I generate the session identification sessionID on the session server and register the session with the connection manager and the state managers of the core engines.” Telecommunications web sites are discussed below with reference to FIG. 2.). Otherwise I inform the client why the login has failed.”

Semantics for the client: “In case of a successful login, I obtain a list of area tags and associated URLs. I expect that the server will communicate messages with respect to the state of the telephone line to my end user unit (telephone) in the future. Otherwise, I do not receive a session identification and no URLs but instead a coded reason for a rejection.”

In order to inform the server SV from the client CL that a signaling according to the signaling protocol according to an embodiment of the present invention is still desired/requested, a so-called “keep alive request” signaling is used which has the following format:

PDUP1: Protocol version (e.g., 1); 1 Word

PDUP2: PDU number 5; 1 Word

PDUP3: Time stamp (client time); 1 Long

PDUP4: empty

PDUP5: Signature; 16 Bytes

The empty PDUP4 indicates the server that this message is a “keep alive request” signaling. The “keep alive request” signaling will be communicated from the client to the server in predefined intervals to indicate “I am alive”. Otherwise the server will “drop” or “forget” the client. Then, the client has to login again (“client hello” signaling) to be connect to the server in this regard.

In response to the “keep alive request” signaling received from the client the server returns a so-called “keep alive response” signaling with the following format

PDUP1: Protocol version (e.g., 1); 1 Word

PDUP2: PDU number 6; 1 Word

PDUP3: Time stamp (server time); 1 Long

PDUP4: empty

PDU 5: Signature; 16 Bytes

The empty PDUP4 indicates the client that this message is a “keep alive response” signaling.

In case the client wants to terminate signaling actions according to the signaling protocol according to an embodiment of the present invention, the client communicates a so-called “logout” signaling to the server with the following structure:

PDUP1: Protocol version (e.g., 1); 1 Word

PDUP2: PDU number 7; 1 Word

PDUP3: Timestamp (server time); 1 Long

PDUP4: Reason code [reasoning from the client to the server for logout]

PDUP5: Signature; 16 Bytes

In response thereto, the server terminates the session related to the client (in case of a telecommunications web site functioning as server, this termination is not performed with respect to the session server).

To inform the client of modifications, variations, changes, etc. of the state of the line to the end user unit (telephone) associated to the client, the server employs a so-called “line state message” signaling with the following structure:

PDUP1: Protocol version (e.g., 1); 1 Word

PDUP2: PDU number 8; 1 Word

PDUP3: Time stamp (server time); 1 Long

PDUP4: new/current of the line; 1 Word

i. Line identification LineID; 1 String

ii. Call identification CallID; 1 String

iii. Caller (User of Client) identification CallID; 1 String; optional

iv. Caller Name (User of Client) Caller name; 1 String; optional

PDUP5: Signature; 16 Bytes

By means of a so-called “new server state” signaling, the server provides the client with information with respect to the second communications environment being not directly related to the telephone line. Rather, that signaling realizes all push semantics possessing the characteristics of indicating an actualization. The “new server state” signaling has the following structure:

PDUP1: Protocol version (e.g., 1); 1 Word

PDUP2: PDU number 9; 1 Word

PDUP3: Time stamp (Server time); 1 Long

PDUP4: Key for type of updated information (e.g., “42” for incoming call in the absence of the user of the client); 1 Word

i. Value of up-dated information (e.g., “5”) or empty string; 1 String

ii. Concerned/affected area tag or 0 if not applicable; 1 Word Pull URL without SessionID (e.g., “https://server.domain.com”); 1 String; optional;

PDUP5: Signature; 16 Bytes

If the amount of used data (PDUP4) is small, the information can be directly transmitted by means of the protocol data unit portion 4 PDUP4. For example, in the case of an incoming call directed to the end user unit (telephone) associated to the client, the following “new server state” signaling can be employed:

PDUP1: Protocol version (e.g., 1); 1 Word

PDUP2: PDU number 9; 1 Word

PDUP3: Time stamp (Server time); 1 Long

PDUP4: “42” (incoming call in the absence of the user of the client)

i. “5”

ii. “12” (indication element for incoming calls in the absence of the user of the client)

iii. - - - (not used)

PDUP5: Signature; 16 Bytes

In case the protocol data unit portion 4 PDUP4 is not sufficient to communicate respective information to the client, this protocol data unit portion can be used to initiate a call from the client CL to the server to obtain the information the server wants to provide to the client.

For example, the server wants to inform the client that a new fax has been received and wants to inform the client about the content of the fax, the following “new server state” signaling can be used:

PDUP1: Protocol version (e.g., 1); 1 Word

PDUP2: PDU number 9; 1 Word

PDUP3: Time stamp (server time); 1 Long

PDUP4: “10” (new fax to the user of the client)

i. “1”

ii. “1” (new browser/TCW window)

iii. “https://server.domain.com”

PDUP5: Signature; 16 Bytes

In case the client wants to instruct the server to perform a specific action with respect to the second communications environment and in particular to components (hardware and/or software) associated to and/or integrated into the end user unit (telephone) associated to the client, a so-called “line action” signaling from the client to the server is employed. Such signaling exhibits the following format:

PDUP1: Protocol version (e.g., 1); 1 Word

PDUP2: PDU number 10; 1 Word

PDUP3: Time stamp (client time); 1 Long

PDUP4: Action code (e.g., “hangup”, “park”, telephone line to . . . ”); 1 Word

i. LineID; 1 Word

ii. CallID; 1 String

iii. Destination; 1 String; optional

iv. Contact Identification ContactId; 1 String; optional

PDUP5: Signature; 16 Bytes

Semantics for the client: “I instruct the server to perform a specific action with respect to my telephone. I expect that the server (continuously) informs me with regard to the performance to the requested action.”

Semantics for the server: “The client requests a specific action to be performed with respect to its telephone. I obtain information with respect to the state of the telephone associated to the client, and forward the same to the client. (In case a telecommunications web site is used as server the request for a specific action with respect to the telephone associated to the client is forwarded to the core engine.).

Examples of action codes used in the protocol data unit portion 4 are “DIAL”, “CREATECONF”, “XFERCONF” and “DETACHCONF”. In case of the action code “DIAL”, and assuming no call identification callID has been transmitted, the “line action” signaling indicates a so-called initiating call which means that the number of the telephone associated to the client has to be called first, and the number of a party to which a telephone communication has to be established subsequently. Here, the line identification lineID is irrelevant. If the “destination” information is used in the protocol data unit portion 4, that information contains a telephone number or any comparable address information of a party to which the client wants to establish a communications link. Otherwise, in case the contact identification contactID is set in the protocol data unit portion 4, the contactID contains a destination contact, the number of which has to be called. In case, the user or the client has already activated his/her telephone and requires connection with a party to be called, the call identification callID indicates the identification of the existing call (i.e. telephone line to the telephone associated to the client). In such a case, the line identification lineID is irrelevant while the “destination” information contains a telephone number or the like of the party to be called. The contact identification contactID comprises an identification of the destination/party to be contacted while the telephone number or the like provided by the “destination” information of the protocol data unit portion 4 overwrites the contact identification contactID therein.

By means of the action code “CREATECONF” the client indicates that a conference call is to be established. Here, the line, call and contact identifications lineID, callID and contactID are irrelevant, while the “destination” information in the protocol data unit portion 4 indicates the number of channels, lines, etc. to be reserved.

The action code “XFERCONF” informs the server that the client intends to transfer a telephone line into a conference call. Here, the call identification callID indicates the identification of the call to which the telephone line was directed so far. The line identification lineID indicates the telephone line to be transferred, while the “destination” information characterizes the call identification callID of the conference call to which the telephone line is to be transferred. The contact identification contactID is irrelevant here.

In order to remove a telephone line from a conference call, the action code “DETACHCONF” is used. Here, the “destination information” and contact identification contactID are irrelevant, while the call identification callID identifies the conference call from which the telephone line should be removed. The line identification lineID characterizes the telephone line to be removed from the conference call.

Further action codes are contemplated for holding, terminating, etc. of telephone lines/connections. In order to obtain a synchronization of the client with the server, and in order to obtain all relevant information with respect to signaling from the calling to the signaling protocol of the present invention, the client communicates a so-called “resynch request” signaling to the server:

PDUP1: Protocol version (e.g., 1); 1 Word

PDUP2: PDU number 11; 1 Word

PDUP3: Time stamp (Client time); 1 Long

PDUP4: empty

PDUP5: empty

Usually, in response to such signaling the server returns a “line state” and/or “new server state” signaling to the client.

Assuming the client is already logged in with respect to the server but has not requested a signaling according to the signaling protocol of the present invention (cf. “client login”; PDU number 3), a so-called “login to session” signaling can be communicated from the client to the server. Such signaling has the following structure:

PDUP1: Protocol version (e.g., 1); 1 Word

PDUP2: PDU number 12; 1 Word

PDUP3: Time stamp (Client time); 1 Long

PDUP4: SessionID

PDUP5: Signature; 16 Bytes

This signaling can be employed if the client is already communicating with the server, for example participates in a conventional Internet session with the server. Then, the “log in to session” signaling communicated from the client, informs the server that the client also wants to participate in a session wherein a signaling according to the signaling protocol of the present invention will be employed with respect to both the client and the server.

If the server determines that failures, errors or the like have occurred with respect to the second communications environment, and in particular to the end user unit associated to the client, a so-called “error message” signaling from the server to the client is used. Such signaling has the following format:

PDUP1: Protocol version (e.g., 1); 1 Word

PDUP2: PDU number 13; 1 Word

PDUP3: Time stamp (Client time); 1 Long

PDUP4: Error code (see table below); 1 Word

i. Error Message (e.g., in English); 1 String

ii. LineId; 1 String

iii. CallId; 1 String

PDUP5: Signature; 16 Bytes

Error codes contemplated for the “error message” signaling are listed in the table below:

| Error | Constant in signaling protocol | | Meaning of | Meaning of |
|---|---|---|---|---|
| Code | header | Error Message | LineId | CallId |
| 0 | EC_OK | OK | irrelevant | irrelevant |
| 1 | EC_NOTAVAIL | Resource unavailable | opt. set | opt. set |
| 2 | EC_INTERNAL | Internal error | opt. set | opt. set |
| 3 | EC_TIMEOUT | Time out | opt. set | opt. set |
| 4 | EC_BUSY | Busy | Indicates | Indicates |
| | | | respective line | respective call |
| 5 | EC_ERROR | Unspecified Server | opt. set | opt. set |
| 6 | EC_PABX | Error in | opt. set | opt. set |
| | | Communication | | |
| | | Subsystem | | |
| 7 | EC_NOPRIVS | Insufficient Privileges | opt. set | opt. set |
| 8 | EC_NOUSERCALL | No Controlling Call | opt. set | opt. set |
| | | to User | | |
| 9 | EC_TRYAGAIN | Try again later | opt. set | opt. set |
| 10 | EC_INVALID_ACTION | Invalid Action | set | set |

The signaling protocol according to an embodiment of the present invention is designed such that all functionalities for generating, analyzing, sending and receiving can be encapsulated in a software library. Further, it is possible that the signaling protocol according to an embodiment of the present invention can be implemented into conventional client software, such as software for personal computers.

FIG. 2 illustrates an embodiment of the present invention where the server SV described above with reference to FIG. 1 is a telecommunications web site TCW, and the client CL is a specific entity SE associated with the telecommunications web site TCW. The discussion above with reference to FIG. 1 applies to the signaling between the specific entity SE and the telecommunications web site TCW.

Further, FIG. 2 illustrates that the second communications environment CE2 is a telephone environment wherein telephones such as the telephones T1 and T2 can communicate via a telephone network TN. Examples for the telephone network TN include PSTN-based networks, GSM networks, UMTS networks, etc. For obtaining information with respect to the second communications environment CE2 the telecommunications web site TCW uses its core engine CE. For establishing communications links from the first communications environment CE1 to the second communications environment CE2, switching means SW, for example a PSTN switch, or comparable units such as gates, gateways and the like are used. In particular, the switching means SW or the like are controlled and/or utilized by the core engine CE.

The terms “web site” and “web page” define sites and sub-sites associated thereto which can be uniquely addressed by means of a single address, like a telephone number or an IP address, a uniform resource locator (URL), etc. A web site may be used in a 3G-communication environment, especially an UMTS environment. A web site may be a site on the Internet with a specific URL, such as a site on the World Wide Web, which can be accessed by Internet visitors, and by the web site host. The web site host is the owner of the web site.

A web site can include one or more web pages. These web pages are part of the one web site. It should be noted that the terms “web site” and “web page” are not to be considered to limit the present invention to conventional Internet web sites and web pages. Thus, the web site and its web page(s), respectively, can be accessed by establishing a communications link from the first end user unit independently of the network(s) employed.

A telecommunications web site is preferably a web site adapted to provide, upon an access event, for private communications between two entities. Preferably, the telecommunications web site corresponds to a first specific entity and is adapted to provide, upon an access by the first end user unit, for private communications between the first end user unit and the first specific entity. The terms “telecommunications web site”, “web site” and “web page” may be understood to encompass software and hardware components effecting these entities. Such components may include one or more processors, for example.

A telecommunications web site is assigned to or personalized for or corresponding to a specific person or entity. Such a specific entity can be a person, a company or any other entity. The specific entity preferably acts as the host of the telecommunication web site. The specific entity may be a single entity, e.g., a specific user or owner (e.g., a single person, a company, a unit of a company, etc.) of the telecommunications web site, a specific address, a specific location, a specific end user unit and the like. As noted above, properties and functions of a telecommunications web site, including its core engine, are described in commonly-assigned U.S. patent application Ser. No. 10/201,446, entitled “Communications Environment,” filed Jul. 23, 2002, and in commonly-assigned U.S. patent application Ser. No. 10/354,709, entitled “Web Site Having an Event Identification Element,” filed Jan. 29, 2003.

In the preceding specification, the present invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for signaling between a client and a server in a first communications environment, comprising:
providing information about a second communication environment to at least one of the client and the server.

2. The method for signaling as recited in claim 1 wherein the providing the information is performed in real-time by actively communicating the information from the client to the server.

3. The method for signaling as recited in claim 1 wherein the providing the information is performed in real-time by actively communicating the information from the server to the client.

4. The method for signaling as recited in claim 1 wherein the server is a telecommunications website and the client is a specific entity associated with the telecommunications website.

5. The method for signaling as recited in claim 1 wherein the first communications environment includes an internet.

6. The method for signaling as recited in claim 1 wherein the second communications environment includes a telephone network.

7. The method for signaling as recited in claim 1 wherein the providing the information includes communicating the information in the first communications environment and further comprising signing the information using a signature before the communicating.

8. The method for signaling as recited in claim 1 wherein the providing the information includes communicating the information in the first communications environment and further comprising encrypting the information before the communicating.

9. The method for signaling as recited in claim 1 wherein the providing the information includes communicating the information in the first communications environment and further comprising:
signing the information using a signature before the communicating; and
decrypting the signature after the communicating.

10. The method for signaling as recited in claim 1 wherein the providing the information includes communicating the information in the first communications environment and further comprising:
signing the information using a signature before the communicating; and
obtaining the signature from a received communication after the communicating.

11. The method for signaling as recited in claim 1 wherein the providing the information is performed using a protocol data unit configured for the information.

12. The method for signaling as recited in claim 1 wherein the providing the information is performed using a protocol data unit including at least one of a first protocol data unit portion configured to indicate a version of a signaling protocol, a second protocol data unit portion configured to indicate a number of the protocol data unit, a third protocol data unit portion including a time stamp, a fourth protocol data unit portion including data useable by at least one of the client and the server, and a fifth protocol data unit portion including a signature.

13. The method for signaling as recited in claim 12 wherein the signature of the fifth protocol data unit portion includes a respective signature of at least one of the first, second, third and fourth protocol data unit portions.

14. The method for signaling as recited in claim 12 wherein at least one of the first, second, third, fourth and fifth protocol data unit portions are symmetrically encrypted.

15. The method for signaling as recited in claim 12 wherein at least one of the first, second, third, fourth and fifth protocol data unit portions are encrypted according to RC 4.

16. The method for signaling as recited in claim 12 wherein the signature of the fifth protocol data unit portion is retrievable according to RFC 2104.

17. The method for signaling as recited in claim 12 wherein the first, the second, the third and the fifth protocol data unit portions each has a predefined respective length.

18. The method for signaling as recited in claim 12 wherein the protocol data unit provides signaling including at least one of a server hello, a client login, a login response, a keep alive requested, a keep alive response, a logout, a line state message, a new server state, a line action, a resynchronization request, a login to session, and an error message signaling.

19. The method for signaling as recited in claim 1 wherein the providing the information is performed using an initialization protocol data unit configured for contacting the server using the client so as to indicate a request for a signaling in accordance with a signaling protocol.

20. The method for signaling as recited in claim 19 wherein the initialization protocol data unit includes at least one of a first portion configured to indicate a version of the signaling protocol, a second portion configured to indicate a number of the initialization protocol data unit, a third portion configured to indicate a time stamp, a fourth portion configured to indicate a major client version, a fifth portion configured to indicate a minor client version, a sixth portion configured to indicate a session cipher, a seventh portion configured to indicate a session key length, an eighth portion configured to indicate a session key, and a ninth portion configured to indicate a signature.

21. A communications environment comprising:
a client; and
a server;
at least one of the client and the server being capable of providing information about a second communication environment to at least one of the client and the server.

22. The communications environment as recited in claim 21 wherein the server is a telecommunications website and the client is a specific entity associated with the telecommunications website.

23. The communications environment as recited in claim 21 further comprising at least a portion of an internet.

24. The communications environment as recited in claim 21 wherein the second communications environment includes a telephone network.

25. The communications environment as recited in claim 21 wherein the at least one of the client and the server is capable of providing the information using a protocol data unit including at least one of a first protocol data unit portion configured to indicate a version of a signaling protocol, a second protocol data unit portion configured to indicate a number of the protocol data unit, a third protocol data unit portion including a time stamp, a fourth protocol data unit portion including data useable by at least one of the client and the server, and a fifth protocol data unit portion including a signature.

26. The communications environment as recited in claim 21 wherein the at least one of the client and the server is capable of providing the information using an initialization protocol data unit configured for contacting the server using the client so as to indicate a request for a signaling in accordance with a signaling protocol.

27. A computer readable medium having stored thereon computer executable process steps operative to perform a method for signaling between a client and a server in a first communications environment, the method comprising:
providing information about a second communication environment to at least one of the client and the server.

28. The computer readable medium as recited in claim 27 wherein the server is a telecommunications website and the client is a specific entity associated with the telecommunications website.

29. The computer readable medium as recited in claim 27 wherein the providing the information is performed using a protocol data unit including at least one of a first protocol data unit portion configured to indicate a version of a signaling protocol, a second protocol data unit portion configured to indicate a number of the protocol data unit, a third protocol data unit portion including a time stamp, a fourth protocol data unit portion including data useable by at least one of the client and the server, and a fifth protocol data unit portion including a signature.

30. The computer readable medium as recited in claim 27 wherein the first communication environment includes at least a portion of an internet.

31. The computer readable medium as recited in claim 27 wherein the second communications environment is a telephone network.
